(19) United States
(12) Patent Application Publication
(10) Pub. No.: US 2003/0149735 A1
(43) Pub. Date: Aug. 7, 2003

(54) Network and method for coordinating high availability system services

(75) Inventors: Kathy T. Stark, Menlo Park, CA (US); Frederic Herrmann, Menlo Park, CA (US); Gia-Khanh Nguyen, Menlo Park, CA (US); Rebecca A. Ramer, Menlo Park, CA (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Sun Microsystems, Inc.

(21) Appl. No.: 09/886,373

(22) Filed: Jun. 22, 2001

(51) Int. Cl. G06F 15/16

(52) U.S. Cl. 709/208; 714/4

(57) ABSTRACT

A network having a plurality of nodes of exchanging information with coordinated system services is disclosed. The network includes a master node having a primary server to run a centralized system service. The network also includes a vice node having a secondary server to run the centralized system service. The network also includes a system service coordinator to coordinate functions regarding the centralized system services at the plurality of nodes.

### BACKGROUND OF THE INVENTION

1. Field of the Invention

The present invention relates to networks for exchanging information. More particularly, the present invention relates to networks having application program interfaces that exchange and manage information between nodes.

2. Discussion of the Related Art

Networks exchange information between different components within the network. For example, the network may have nodes with software and hardware components that exchange information. In addition, software applications on the nodes may require information from other parts of the network to complete a process. Therefore, the network needs to manage the flow of information to the different nodes. Current systems may be unable to handle increased information traffic or resolve failed components. Further, solutions to problems with current systems may result in increased overhead, costs, and a reduction of network resources.

### SUMMARY OF THE INVENTION

Accordingly, the embodiments of present invention may be directed to a network and method form coordinating system services. According to one embodiment, a network, having a plurality of nodes for exchanging information is disclosed. The network includes a master node within the plurality of nodes. The master node includes a primary server to run a centralized system service. The network also includes a system service coordinator on each of the plurality of nodes. The system service coordinator coordinates a function regarding the centralized system service.

Accordingly to another embodiment, a node within a network of nodes for exchanging information is disclosed. The node includes a centralized system service to run on a primary server. The node also includes a system service coordinator to coordinate a function regarding the centralized system service.

According to another embodiment, a network having a plurality of nodes is disclosed. The network includes a master node having a primary server to run a centralized system service. The network also includes a vice node having a secondary server to run the centralized system service. The network also includes a system service coordinator to coordinate functions regarding the centralized system service at the plurality of nodes.

According to another embodiment, a method for coordinating a system service within a network having a plurality of nodes is disclosed. The method includes receiving a request at a system services coordinator. The system services coordinator has a component at each of the plurality of nodes. The method also includes using a callback sequence for performing a function at one of the plurality of nodes in response to the request. The method also includes reacting to the function by the system service on the node and communicating the reaction to the system services coordinator.

According to another embodiment, a method for coordinating a function for a system service on a node is disclosed. The method includes receiving a callback sequence at the system service from a system services coordinator, the system services coordinator is in communication with a primary server of the system service. The method also includes determining levels of the callback sequence. The levels correlate to stages of completing the function. The method also includes receiving the levels at the system services coordinator. The method also includes publishing events from the node by the system services coordinator correlating to the received levels.

According to another embodiment, a method for initializing a node within a network having centralized system services is disclosed. The method includes registering with the centralized system services coordinator. The method also includes triggering an initialization function having levels. The method also includes receiving notification at the system services coordinator for completing the levels.

According to another embodiment, a method for coordinating initialization in a network having a plurality of nodes is disclosed. The method includes registering centralized system services within the network with a system services coordinator. The method also includes electing a master node within the network and sending information on the master node to the plurality of nodes. The method also includes using callbacks registered at the system services coordinator to trigger initialization levels at the plurality of nodes. The method also includes informing the plurality of nodes when the master node completes the initialization levels via the system services coordinator.

According to another embodiment a method for switching over a master node having primary servers for centralized system services within a network having a plurality of nodes is disclosed. The method includes informing a system services coordinator on the master node of a loss of master eligibility on the master node. The method also includes involving switchover callbacks, registered at the system services coordinator. The method also includes transferring states of the primary servers to secondary servers for the centralized system services at a vice node.

According to another embodiment, a method for failing a master node having primary servers for centralized system services within a network having a plurality of nodes is disclosed. The method includes claiming mastership of the network at a vice node and informing the centralized system services via a system services coordinator. The method also includes recovering states of the primary servers on the master node to secondary servers of the centralized system services on the vice node.

According to another embodiment, a method for demoting a master eligible node within a network for exchanging information is disclosed. The method includes initiating a demote callback sequence from a system services coordinator. The method also includes transitioning centralized system services servers on the node to a spare state. The method also includes updating the system services coordinator.

According to another embodiment, a method for promoting a node to be master eligible within a network for exchanging information is disclosed. The method includes initiating a promote callback sequence from a system services coordinator. The method includes transitioning centralized system servers on the node to an availability state. The method also includes updating the system services coordinator.

According to another embodiment, a method for disqualifying a node from being master eligible within a network for exchanging information is disclosed. The method includes initiating a disqualify callback sequence from a system services coordinator. The method also includes getting a master eligible attribute at the node. The method also includes transitioning centralized system servers on the node to an offline state.

According to another embodiment, a method for qualifying a node to be master eligible within a network for exchanging information is disclosed. The method includes initiating a qualify callback sequence from a system services coordinator. The method also includes getting a master eligible attribute at the node. The method also includes transitioning centralized system servers on the node to a spare state.

According to another embodiment, a method for shutting down a node within a network for exchanging information is disclosed. The method includes invoking callbacks of centralized system services on the node by a system services coordinator. The method also includes requesting the node be- removed from the network by the system services coordinator. The method also includes terminating the system services coordinator.

According to another embodiment, a method for removing a node from a network is disclosed. The method includes initiating a shutdown callback sequence from a system services coordinator, wherein the shutdown callback sequence includes levels. The method also includes notifying the system services on the node. The method also includes terminating the system services coordinator.

According to another embodiment, a method for coordinating centralized system services on a node within a network is disclosed. The network exchanges information with the node. The method includes initializing the node by an initialization function according to a system services coordinator. The method also includes invoking a callback sequence at the node by the system services coordinator. The method also includes updating the centralized system services and non-centralized system services with information received by the system services coordinator. The method also includes communicating with a master node within the network and synchronizing the initialization function with the master node. The method also includes determining a change in configuration of the node within the network. The method also includes executing a function at the node according to the system services coordinator. The function responds to the change in configuration.

The network connects a set of nodes known as a cluster. Each cluster node may run a number of system services that together collaborate to provide a distributed environment for applications. The environment is accessible on all nodes of the cluster through Application Program Interfaces (“APIs”). The cluster environment APIs allow the implementation of applications that are comprised of components. Some components may run as secondaries that back-ups to primary application components.

When run in the cluster environment, the applications are highly available because a failed application component may be restarted automatically if it fails, or the environment may cause a secondary component to take over from a failed primary on a different node. The system services that provide the cluster environment to the applications may be highly available because the services are implemented with redundant servers running on different nodes in the cluster. The redundancy is implemented either by having a server for the service on each cluster node, or by having one centralized server on a designated “master” node with a back-up secondary for the server on a different “vice” node.

The system services that provide the cluster application environment are interdependent. The servers should coordinate their actions relative to the state of other servers during system transitions. The coordination should happen among all services, both centralized and non-centralized. Non-centralized services may be subdivided further as local, distributed, local agent for centralized service, and the like. These subdivisions, however, are not important with regards to the present invention.

The disclosed embodiments may be mechanisms to coordinate the servers of the cluster system services during system transitions. The transitions during which the coordination is performed may include node initialization. Node initialization occurs when servers on a node should be coordinated with each other, and with the initialization state of servers of the master node. Another transition may be node shutdown. Node shutdown occurs when servers on the node should be coordinated with each other to avoid error conditions that trigger abrupt error-recovery actions that pre-empt orderly shutdown.

Another transition needing coordination between the servers of the cluster system services may include switchover of the master node. A switchover is the orderly change of the designated master node. Centralized servers on the master node should be coordinated with each other, with their secondaries on the vice node, and with the action of changing the designation of the master from one node to another. Another transition may be failover of the master node. A failover is an abrupt change of the designated master node caused by the failure of the previous master node. The secondary centralized servers on the former vice node should be coordinated with each other in their transition to being the primary servers for the centralized system services when the node is elected master.

The coordinate mechanism comprises a local cluster system services coordinator server on each node of the cluster network. The local cluster system services coordinator communicates with cluster system services coordinator servers on other nodes. The cluster system services coordinator also communicates with local servers that register with it via an API. The cluster system services coordinator coordinates the actions of the servers by invoking callback functions registered by the servers at different stages during system transitions.

Additional features and advantages of the disclosed embodiments will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates a cluster network having nodes in accordance with an embodiment of the present invention;

FIG. 2 illustrates a master node and a vice node in accordance with an embodiment of the present invention;

FIG. 3 illustrates a cluster system service coordinator in accordance with an embodiment of the present invention;

FIG. 4A illustrates a flowchart for initializing a master eligible node in accordance with an embodiment of the present invention;

FIG. 4B illustrates a flowchart for initializing a subset of services on a non-master eligible node in accordance with an embodiment of the present invention;

FIG. 4C illustrates a flowchart for initializing non-centralized system services on a node in accordance with an embodiment of the present invention;

FIG. 5A illustrates a flowchart for switching over a master node in accordance with an embodiment of the present invention;

FIG. 5B illustrates a flowchart for failing over a master node in accordance with an embodiment of the present invention;

FIG. 5C illustrates a flowchart for promoting a node within a cluster network in accordance with an embodiment of the present invention;

FIG. 6A illustrates a flowchart for disqualifying a node in accordance with an embodiment of the present invention;

FIG. 6B illustrates a flowchart for qualifying a node in accordance with an embodiment of the present invention;

FIG. 7A illustrates a flowchart for shutting down a non-master node in accordance with an embodiment of the present invention;

FIG. 7B illustrates a flowchart for shutting down a master node in accordance with an embodiment of the present invention;

FIG. 7C illustrates a flowchart for shutting down a vice node in accordance with an embodiment of the present invention; and

FIG. 8 illustrates a flowchart for implementing CSSC functions on a cluster network in accordance with an embodiment of the present invention.

### DETAILED DESCRIPTION OF THE PREFERRED EMBODIMENTS

Reference will now be made in detail to the preferred embodiment of the present invention, examples of which are illustrated in the drawings.

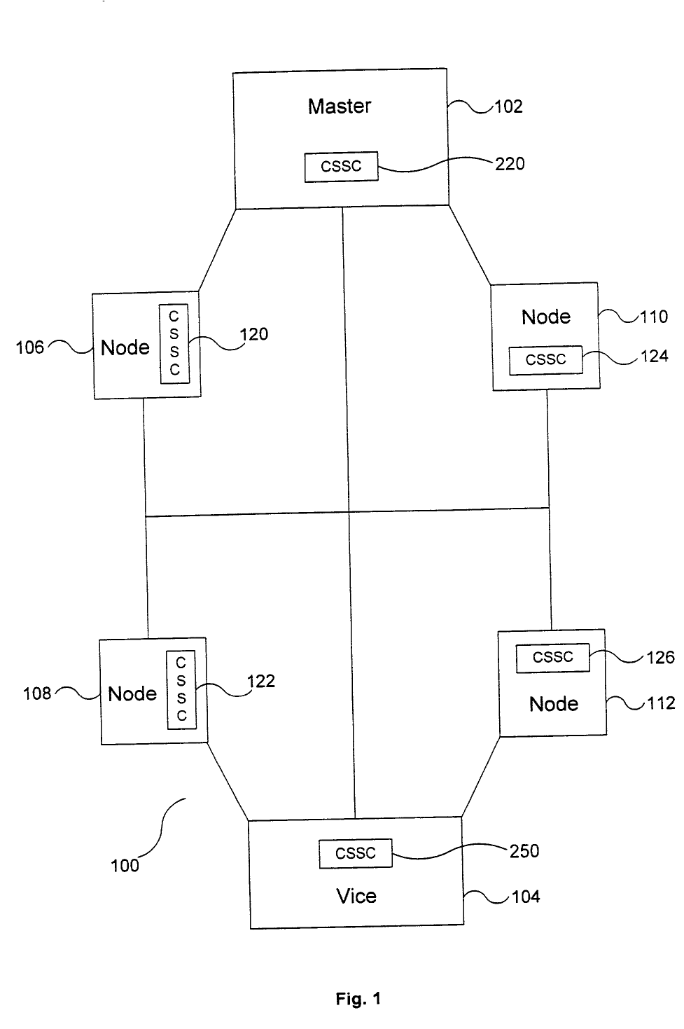

FIG. 1 depicts a cluster network 100 in accordance with an embodiment of the present invention. Cluster network 100 exchanges information between nodes. Preferably, this information is used by applications on the different nodes, and may be placed into the network by the applications. Network 100 may exchange information using high availability platforms that are coupled by any medium suitable for carrying data, such as local area networks (“LANs”), virtual LANs, fiber optic networks, cellular networks, TCP/IP capable networks, and the like. Preferably, cluster network 100 is a digital network capable of exchanging digital data. More preferably, cluster network 100 is implemented with a carrier-grade transport protocol, which is a high availability network connection with redundant interconnects.

Cluster network 100 includes high availability platforms. High availability may indicate that these resources should not fail or be unavailable for any significant period of time. For example, if cluster network 100 carries information pertaining to emergencies or security, then resources and applications in cluster network 100 should not be unavailable for more than a few seconds. Cluster network 100 may include high availability system services that are the distributed computing infrastructure which the high availability-aware applications rely upon to be available continuously. Service types include distributed services, cluster services, availability management services and external management services.

Cluster network 100 includes nodes 102, 104, 106, 108, 110 and 112. Cluster network 100 may include additional nodes or only a subset of the nodes depicted. The nodes may be high availability platforms for exchanging information within cluster network 100. Node 102 may be a master node, and node 104 may be a vice node within cluster network 100. Master node 102 is unique in cluster network 100 because some core system services may have their central servers running on master node 102. Thus, the primary servers of the centralized system services run on master node 102. The initialization and the recovery of such services are tied to the selection and the failover of master node 102. Other nodes may not have the primary servers running the centralized system services. These nodes, however, may be “master-eligible” in that they have the capability to act as a master node, but currently are in a spare state. Other non-centralized system services may be provided by an agent or server local to the other nodes, but may need initialization in relation with the individual node and with the readiness of the centralized system services on master node 102.

Master node 102 includes cluster system service coordinator (“CSSC”) 220. A cluster network system service coordinator is a service of a high availability platform that coordinates the startup or initialization, shutdown, failure recovery and switch-over of other high availability platform system services within the cluster network. A CSSC provides its coordination service by invoking actions in an ordered sequence. The actions may occur in response to cluster network membership changes, node role assignment changes, and to operations initiated by administrative and availability-management actions. A CSSC component is located on every node within cluster network 100.

CSSC 220 provides an application program interface (“API”) for system services to register callback functions that are invoked at different levels of the sequences executed by CSSC 220. Each system service registers callback actions that adjust the service to the events that trigger the sequence. A service coordinates its actions with other services by registering at a particular level, before or after the levels at which other services register their actions.

Vice node 104 is the backup for master node 102. Vice node 104 takes the role of master node 102 if it fails. Further, each centralized system service may have a secondary server running on vice node 104, along with a primary server on master node 102. Vice node 104 includes CSSC 250.

Nodes 106, 108, 110 and 112 are coupled to master node 102 and vice node 104. Nodes 106, 108, 110 and 112 may be nodes that do not have centralized system servers running on them. Nodes 106, 108, 110 and 112 may have non-centralized systems servers running on them. CSSCs 120, 122, 124 and 126 may run on nodes 106, 108, 110 and 112, respectively, and communicate with CSSC 220 on master node 102.

A node within network 100 may be shutdown, and, to some extent, rebooted. For example, a node may be rebooted as part of a repair action. Relying on the traditional shutdown or reboot facility of the node operating system may not be sufficient for a high availability system. Better control of the shutdown process may be desired to allow an orderly shutdown of the high availability system services on the node to avoid unnecessary error conditions and reactions. It may be desirable to be able to shutdown only the high availability system services on the node without a shutdown of the operating systems. Therefore, a CSSC component server runs on every node within network 100. The CSSC component server, such as CSSCs 120, 122, 124, 126, 220 and 250, on each node provides local service to the node, but synchronizes its actions with the CSSC components on the other nodes.

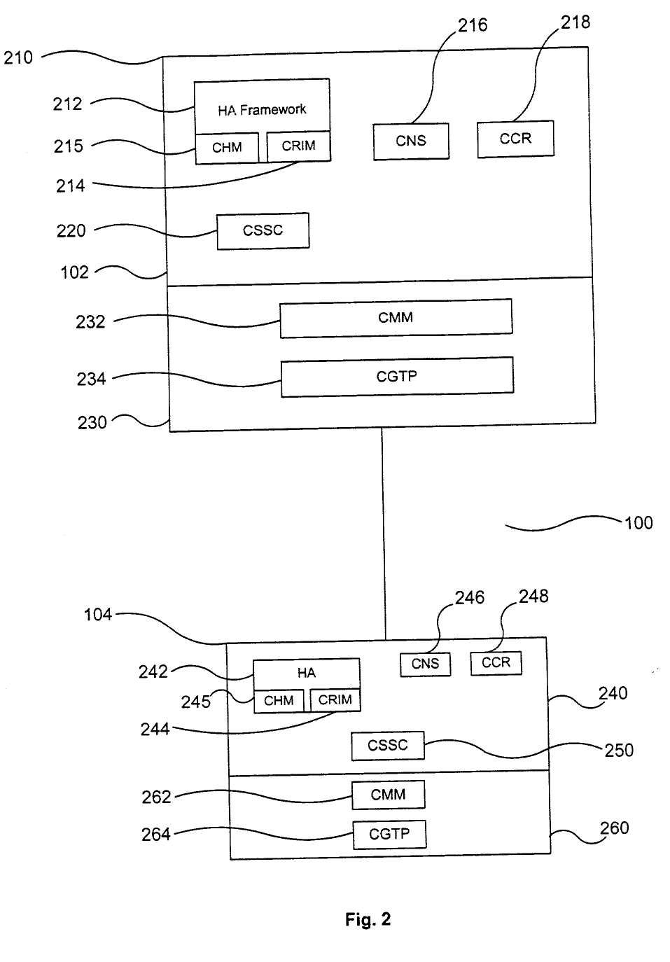

FIG. 2 depicts master node 102 and vice node 104 in accordance with an embodiment of the present invention. As noted above, master node 102 and vice node 104 may be within cluster network 100. Master node 102 and vice node 104 run centralized systems services for managing and exchanging information in cluster network 100. Other system services may run on other nodes, but not the centralized system services. Master node 102 may include high availability level 210 and operating system level 230. Operating system level 230 may be those cluster services that are operating system specific, but function as add-ons to the regular operating system facilities. Vice node 104 may include high availability level 240 and operating system level 260, which correlate to the respective levels of master node 102.

The centralized system services for cluster network 100 provide the application level environment and a portion of the infrastructure that organizes the individual nodes in the distributed environment into a cluster. The cluster, as an aggregate entity, provides a set of highly available services. The cluster services include cluster membership monitor (“CMM”) 232 within operating system level 230. CMM 232 and carrier grade transport protocol (“CGTP”) 234 provide the primite infrastructure for forming the cluster. CMM 232 is a distributed service and runs on each node of cluster network 100. CGTP 234 is the high availability networking facility used by CMM 232, as well as other services on cluster network 100, to communicate between nodes. CMM 232 may provide the following functionality for master node 102. CMM 232 may provide mastership information such as identification for master node 102 and identification for vice node 104. CMM 232 further provides information on each node that is a member of cluster network 100, including address information that may be used with the network communication services of the operating system to communicate with servers on the different cluster nodes. Due to the issue of the high availability of the hostname to Internet Protocol address service, CMM 232 may provide the host IP addresses directly.

In addition, CMM 232 may provide a cluster node list having the current dynamic information of nodes in cluster network 100. CMM 232 may provide notification for changes of membership and mastership within cluster network 100. Further, CMM 232 may be informed to shut down, and make the node leave cluster network 100. CMM 232 may be informed of node attribute changes and act accordingly, such as making a mastership switch. CMM 232 may take input of the initial presumed node list and only nodes in the list may be allowed to join cluster network 100.

Some of these functionalities may be provided in a general API, or via a callback register with CMM 232. Some functionalities may be done via a restricted API, while others may be done via a change of the configuration data in cluster configuration repository (“CCR”) 218. CCR 218 is disclosed below. The node to release the mastership, such as master node 102, will have its master-eligibility attribute “disqualified” in the configuration data of CMM 232. Another term for disqualified may be “locked.” CMM 232 may be notified of the change and implements its effect, such as releasing the mastership, or vice-mastership, of the node, and not participating in future election until the master-eligibility attribute is “qualified.” Another term for qualified may be “unlocked.” Additional functionalities may read the configuration tables for CMM 232 in CCR 218. Special dispositions may be made to have special tables accessible locally before the cluster network 100 is formed.

CCR 218 is located within high availability level 210. High availability level 210 also includes cluster name service (“CNS”) 216 and CSSC 220. High availability level 210 includes high availability framework 212. High availability framework 212 may include a component role assignment manager (“CRIM”) 214 and a component health monitor (“CHM”) 215. These services may be responsible for assigning component active and stand-by roles. CRIM 214 and CHM 215 also may be responsible for failure detection and reporting, as well as assisting with node recovery.

CRIM 214 may be responsible for the assignment of roles and services, as well as the failover of the components of highly available services. An extension of the functionalities of CRIM 214 could include the issues of system services. Due to the initialization and failover of its own services and its dependency on other system services, however, CRIM 214 is not the preferable component to resolve system service issues.

CSSC 220 provides a service for the system services that may be it similar to the service that CRIM 214 provides for application components. CSSC 220 is separate from CRIM 214 to avoid problems related to startup and failover of interdependent system services, as disclose above.

CRIM 214 assigns roles to application components and handles the failover of these components to maintain their availability. CSSC 220 may not assign roles to system services, but, instead, informs systems services of node role changes to allow each to determine how to adapt to the change. The callback sequences of CSSC 220 allow interdependent actions to be coordinated. The functionality of CSSC 220 is not dependent on the services that are in flux during node failover or switchover.

Not all system services may utilize CSSC 220 to coordinate their startup, shutdown and availability. Primitive distributed and cluster services such as network communication services and CMM 232 should be available before CSSC 220 begins to operate. Some services may be free enough of interdependencies with lower level services as to be managed by CRIM 214. The role of CSSC 220 is to support CRIM 214 and the interdependent services that provide the container for the application components on the high availability platform.

The system services disclosed above may use centralized, distributed or local distribution models. The centralized system services provide cluster-wide services from designated primary servers, such as master node 102 and vice node 104. By convention, the primary server of a centralized service runs on the node elected by CMM 232 to play the master role, such as master node 102. The node elected to play the vice master role runs the active-standby secondary server that is ready to take over as primary should the primary fail. Other servers running on master-eligible nodes either are spare or offline. Services that use this model include CNS 216, CCR 218 and CRIM 214.

Distributed and local system services have servers on each peer node of the cluster network 100 that respond to service requests on the local node. Distributed service servers cooperate across nodes to provide a service that is global to the cluster network 100. Examples of services includes the cluster event service (“CES”) and the cluster replicated checkpoint service (“CRCS”). A checkpoint is internal data from an application component that is stored outside the component. A checkpoint may be read by the component when it is restarted to recover data and resume operation after the component is restarted. A checkpoint also may be read by the secondary of a component so that the secondary may enact an immediate take over operation if the primary component fails. Thus, the CRCS provides a mechanism for creating, reading and writing checkpoints within cluster network 100.

Local services operate within the scope of the node that runs the server. An example may be CHM 215. Both distributed and local services are available or not available to the applications and services running on a node.

CSSC 220 provides a mechanism so that services of all distribution models may resolve their interdependencies. For example, most services may have a dependency on a centralized system service, such as the naming and directory service, when initializing. CSSC 220 may be aware when the primary service is operational on master node 102 and can control the pace of initializing a fully distributed service, such as the CES, on other nodes joining the cluster.

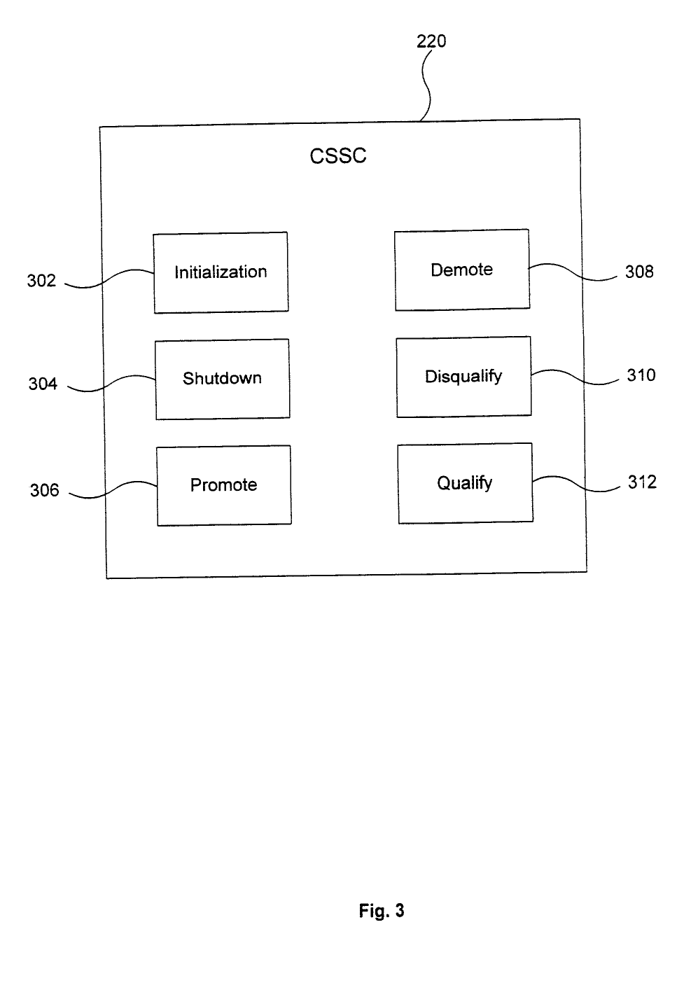

FIG. 3 depicts a CSSC component with cluster network 100 in accordance with an embodiment of the present invention. The CSSC component, as disclosed above, is a high level entity that performs system services initialization and shutdown, and the recovery of the centralized system services. A CSSC component, such as CSSC 220, may exist on each cluster node within cluster network 100, and may provide certain functionalities. Further, the CSSC component uses callback sequences to perform its functionalities. Callback sequences may be a staged invocation of client callback functions in reaction to administrative operation or cluster membership changes. Stages in the sequence may be known as levels. The different types of callback sequences include initialization, shutdown, promote, demote, qualify and disqualify. The callback sequence types correspond to the different membership and administrative changes that trigger each sequence.

Callback sequences enable the system services on a node to react in an orderly manner to administrative operations and changes in cluster network 100 membership. Administrative management control operations or CMM 232 notifications cause CSSC 220 to start a callback sequence. Client system services register callback functions to be invoked during callback sequences at specified levels.

The system service distribution model determines what each system service needs to do for the different types of callback sequences. Servers of the centralized system services use callback functions invoked during callback sequences to transition to the appropriate availability state. CSSC 220 orchestrates and sets the context of the callback functions performed by system services servers during each callback sequence. Clients are responsible for informing their respective component CSSC when a callback function is completed.

CSSC 220 may cancel a callback sequence at any time in response to a change in cluster network 100. CSSC 220 notifies clients that a sequence is canceled through a special callback function. Upon receiving the notification, client services are expected to clean-up any residue from the canceled sequence, and prepare for a new callback sequence invocation.

Referring to FIG. 3, the callback sequences include initialization sequence 302, shutdown sequence 304, promote sequence 306, demote sequence 308, disqualify sequence 310 and qualify sequence 312. CSSC 220 initiates initialization callback sequence 302 on a node when the node joins the cluster, or network 100. A cluster master node, such as master node 102, should be elected before system service initialization on any node may begin. During initial cluster formation, the services on master node 102 should achieve a level of initialization before service initialization may begin on other nodes joining cluster network 100. Centralized system service servers may be initialized in primary, secondary, spare or offline states, depending on the state of the node and the role the node plays in cluster network 100. The servers of non-centralized and local services may initialize in an active state.

CSSC 220 with other CSSC components initiates shutdown sequence 304 before a node is rebooted. A node may be rebooted for various administrative purposes. Prior to rebooting a node, any servers of centralized system services on the node should be placed into an offline state. The system services then are shut down and the node rebooted. CSSC 220 also may support system service shutdown without node reboot.

CSSC 220 initiates promote callback sequence 306 on a node after it has received notification from CMM 232 that the node has been elected to assume the master or vice master role, or a switch over. After cluster network 100 formation, a node subsequently may be promoted due to another node's failure or as the result of an administrative action. Possible node promotions include a node playing the vice master role promoted to playing the master role, or a master-eligible node playing no special role promoted to playing the vice master or master role.

The node role changes affect the centralized system services. The servers of the centralized system services on the promoted node are informed of the new role of the node to allow the services to transition to the appropriate availability state. For example, if a node playing the vice master is elected to play the master role, then the secondary centralized system services on the node become primary. The servers of non-centralized system services and local system services remain in an active state when a node is promoted.

CSSC 220 initiates demote callback sequence 308 when a master or vice master role is about to lose the master role, or a failover. A node may be demoted due to an administrative action. Demotions include a node playing the master role or vice master role becoming a node playing no special role. A node playing the master role may be demoted directly to playing the vice master role, or may be demoted to a spare, after which the node may be promoted to vice master.

Prior to node demotion, CSSC 220 initiates demote callback sequence 308 to allow the servers of the centralized system services to prepare for the node's role change and transition to a spare state. The servers of distributed and local system services remain in an active state before, during and after a node demotion.

CSSC 220 initiates disqualify callback sequence 310 when a node is disqualified from being elected to the master role. As part of an administrative action to disqualify a node, the node's qualification attribute is set to prevent CMM 232 from assigning the master or vice master role to the node.

CSSC 220 initiates qualify callback sequence 312 when a node becomes eligible to play the master role. CSSC 220 initiates qualify callback sequence 312 after the node's qualification attribute is set to allow CMM 232 to assign the master or vice master role to the node. Qualify callback sequence 312 allows centralized system servers to transition from offline to a spare state.

For each callback sequence performed on a node, dependencies may exist between services on the same node and dependencies on centralized system services possibly located on another node. CSSC 220 uses levels for each callback sequence to coordinate the interdependencies. Each system service runs callback functions at predetermined levels with the assumption that other system services from which it depends have progressed through the callback sequence to the degree required. A system service may use just one level per callback sequence, but interdependencies may exist between services that cause a service to run callback functions at more than one level.

The number of levels that each callback sequence uses are tunable parameters of CSSC 220. Each service component may have tunable parameters for each level of each type of callback sequence for which it registers. For each callback sequence, CSSC 220 controls the progression through the levels, and ensures that each system service runs and completes the callback functions for any specific level before proceeding to the next level. CSSC 220 also coordinates how levels are reached among multiple nodes when callback sequences of the same type are active, during initial cluster formation.

CSSC 220 provides an API for registering callback functions to be invoked at a specific callback sequence level, as well as an interface for registering for notification of the cancellation of a sequence. CSSC 220 provides an API for control operations needed by administrative control of system services including interfaces to shutdown a node, and to control switchover of a master node. CSSC 220 publishes events to other CSSC components on nodes when it completes certain actions and operations.

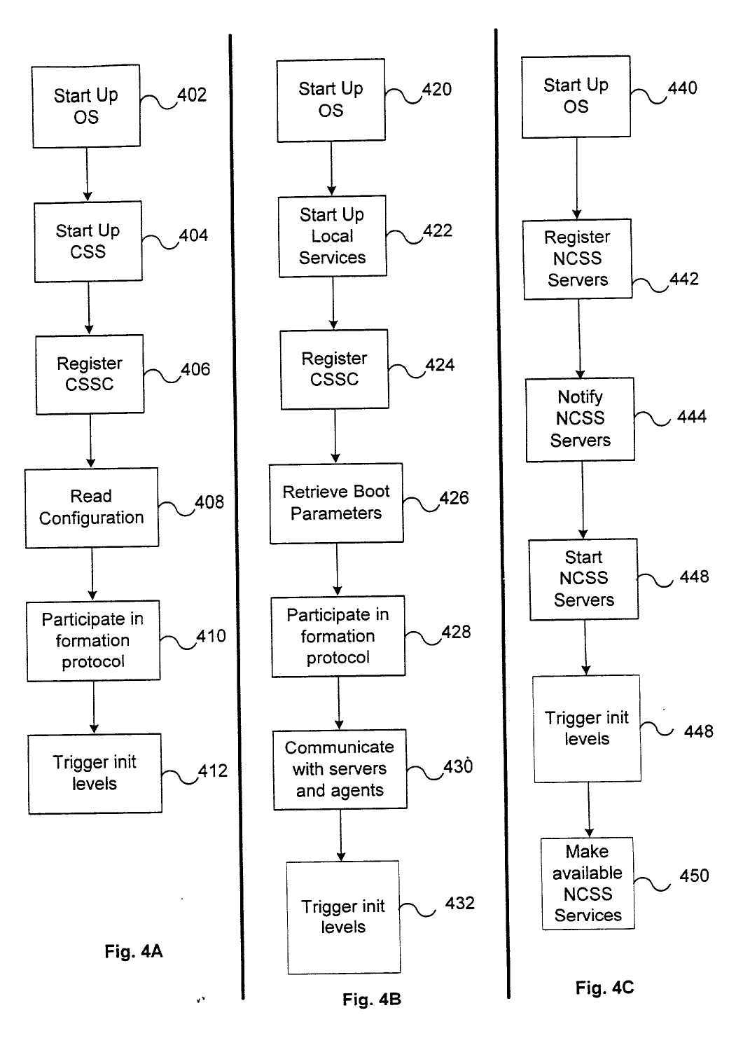

FIGS. 4A-C depict flowcharts for an initialization function in accordance with embodiments of the present invention. Reference will be made to the components depicted in FIG. 2. Different nodes may initialize in different manners, with the coordination for the initialization performed by CSSC 220. FIG. 4A depicts a flowchart for initializing a master-eligible node, such as master node 102 or vice node 104, in accordance with an embodiment of the present invention. Step 402 executes by starting up the operating system on the node. Part of the initialization scripts installed on the node may start the high availability components and services on the node.

Step 404 executes by starting up the centralized system services servers, along with the CSSC 220 and CMM 232. CSSC 220 registers with CMM 232. Step 406 executes by registering the centralized system services servers with CSSC 220. Registration of local and distributed servers, such as the CES and the CRCS, also occurs in this step. The centralized system servers indicate their initialization levels to CSSC 220. CMM 232 retrieves information from the boot parameters of master node 102 that it is a master-eligible node. CMM 232 may accomplish the information retrieval by reading the startup configuration data from the local CCR 218. CSSC 220 may wait to be notified by CMM 232 of the mastership information. The centralized system services wait for their initialization levels.

Step 408 executes by reading a high availability system startup configuration table from CCR 218.

Step 410 executes by participating in cluster network formation protocol with CMM 232. CMM 232 sends out its node information. At this point, cluster network 100 may be formed. CMM 232 notifies CSSC 220 of the mastership information.

Step 412 executes by triggering the initialization levels. The levels are triggered sequentially by CSSC 220 on master node 102 using the callbacks registered by the centralized system services servers. Each of the servers may proceed with the initialization. The server for CNS 216 on master node 102 may continue its initialization to become the CNS primary server to make CNS services available to cluster network 100. At each initialization level, servers may utilize only services that have completed initialization at an earlier initialization level. Each time a new initialization level is reached on master node 102, CSSC 220 informs the other CSSC components on other nodes via their own protocol.

In parallel, the centralized system servers on vice node 104 may proceed to a full initialization to become the secondary servers. The secondary servers may by synchronized with the notification from CSSC 220 of reached initialization levels, but indirectly of master node 102. Secondary servers on vice node 104 may not be restricted by the interdependency rule. If other master-eligible nodes exist, then the centralized system servers on those nodes may go to a spare state and wait until the node is promoted or disqualified.

FIG. 4B depicts a flowchart for initializing a subset of services on a non-master node in accordance with an embodiment of the present invention. Step 420 executes by starting up the operating system on the node. Part of the initialization scripts installed on the node may start the high availability components and services on the node.

Step 422 executes by starting up the local services agents, as well as the CSSC and CMM components on the node. The CSSC registers with the CMM. Step 424 executes by registering the local services agents with the CSSC. The local agents initialize to the point to await knowing which node is the master and that their servers are initialized. If a local synchronization becomes necessary, then the local agents may register with the CSSC for their initialization level to be triggered.

Step 426 executes by retrieving the boot parameters for the CMM that the node is not master-eligible. Step 428 executes by participating in cluster network formation protocol with the CMM. When mastership is established, the CMM notifies the CSSC which in turn informs the local agents of the centralized system services. The CSSC triggers the local initialization levels in synchronization with the initialization levels reached on master node 102.

Step 430 executes by communicating with local servers and agents from the primary servers. As a result, the centralized system server's local agents may communicate with their primary servers and provide the services at the node. Step 432 executes by triggering the initialization levels.

FIG. 4C depicts a flowchart for initializing non-centralized system services on any node in accordance with an embodiment of the present invention. The flowchart of FIG. 4C may be run in conjunction with FIGS. 4A and 4B. Step 440 executes by starting up of the operating system on the node. Part of the initialization scripts installed on the node may start the high availability components and services on the node.

Step 442 executes by registering non-centralized system services servers with the CSSC at the node. By registering, the CSSC may trigger the initialization levels in the non-centralized system services servers. The non-centralized systems services servers wait for their expected levels to arrive. In addition, the non-centralized system services may register to receive mastership information.

Step 444 executes by notifying the non-centralized system services servers that mastership is established. The non-centralized system services servers may received this information from the CSSC. Step 446 executes by starting the non-centralized system services servers on the node. Step 448 executes by triggering initialization levels. The CSSC triggers the local initialization levels in synchronization with the initialization levels reached on master node 102. This sequencing process should bring the non-centralized system services servers to full initialization.

Step 450 executes by making the non-centralized system services available on the node. The services may interact with their counter parts on other nodes within cluster network 100.

A newly joined node may be initialized in the same manner as disclosed above, but with a few differences. As the mastership should be established, the new node may query master node 102 using the API for CMM 232. In addition, because the centralized system services already are available and the maximum initialization levels reached, the CSSC on the new node performs the local initialization levels and invokes the callbacks. The servers/agents may proceed to full initialization to provide services on the node. If a node joins cluster network 100, and is elected to vice master node 104, then this fact is known before the CSSC triggers the initialization sequence. The centralized system services servers on the node may initialize through this sequence to become the secondary servers for their services.

Registration of the callback with CSSC 220 provides the means for CSSC 220 to trigger initialization on the nodes in cluster network 100. Callbacks for an initialization level may be executed in parallel. When all callbacks of the level returns, the initialization level is considered to be locally reached. CSSC 220 triggers an initialization level N+1 if the level N is reached on master node 102 and the local node. A local synchronization is supported between the centralized system services and the non-centralized system services servers/agents within the global synchronization of initialization for cluster network 100. An entity may register for multiple initialization levels to perform its initialization with a better degree of synchronization.

Initialization also may include startup dependencies and order between relevant services during normal operations. Centralized system services may depend upon CMM 232 and CSSC 220. CRIM 214 and other high availability centralized system services may depend upon CCR 218 and CNS 216. CCR 218 may depend upon CNS 216. AR of the above services may depend upon CHM 215 for early audits. CSSC 220 and CMM 232 may depend upon CCR 218 for their configuration data. Thus, the initialization scripts installed on the nodes may start the following system services this order: CHM 215, CCR 218, CMM 232 and CSSC 220. Other a services may be started in any order after those listed above. The services may register with CSSC 220, and their initialization may be sequenced by CSSC 220.

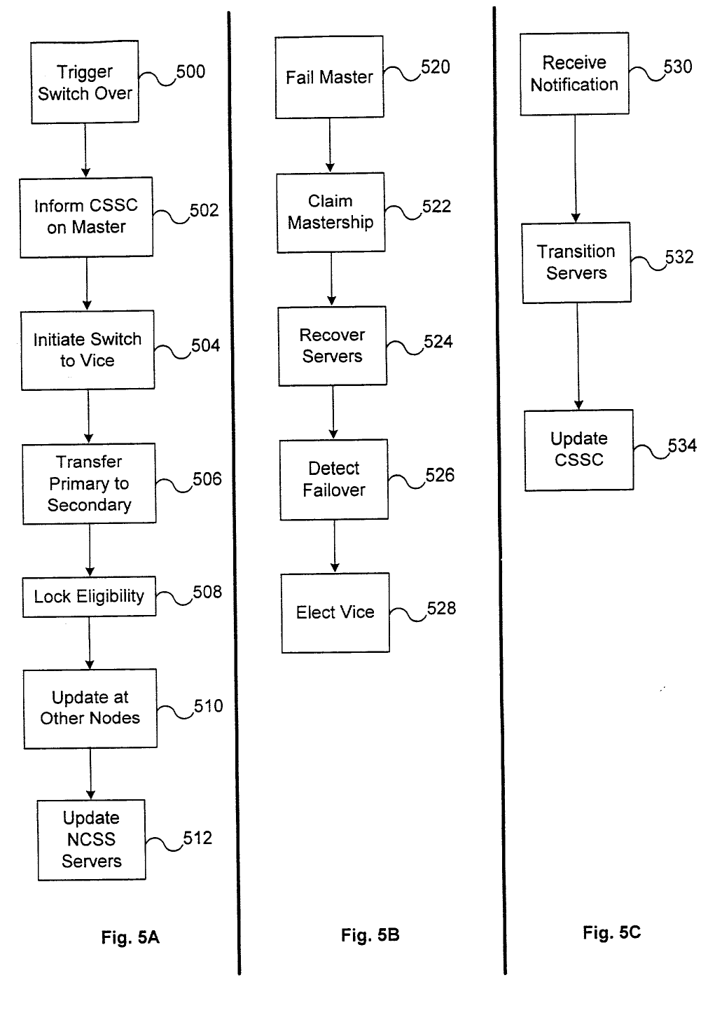

FIGS. 5A-C depict flowcharts for promoting and demoting nodes within a cluster network in accordance with embodiments of the present invention. The promote and demote functions may be called switchover and failover of the nodes. Promote and demote functions occur when a master node is removed from mastership or a master-eligible node is elected to master node or vice node.

FIG. 5A depicts a flowchart for switching over a master node in accordance with an embodiment of the present invention. Step 500 executes by triggering the switchover. A master node switchover may be triggered either by an escalated recovery action or a management command. Step 502 executes by informing CSSC 220 on master node 102 that master node 102 can no longer be the master node. The notification may be done using the CSSC interface to request the shutdown, disqualification or switchover of the node.

Step 504 executes by initiating the switch to vice node 104 by CSSC 250. The switch over of the centralized system services may be initiated by invoking the switchover callbacks registered by the local centralized system services primary servers. Switchover callbacks may be those callbacks registered for the “demote” callback sequence. This action constitutes the start of a centralized system services switchover, but not a new mastership.

Step 506 executes by transferring the state of each centralized system services primary server to the secondary server. When this is completed, the secondary servers, except for CNS 246, update the bindings to the service in CNS 216. The operation may be executed by the server for CNS 216 that updates the secondary servers. At this point, except for CNS 246, other centralized system services may be provided by the new primary servers on vice node 104. The old primary servers on master node 102 should complete current requests and reject new requests. When CNS 216 completes its state transfer to the secondary server on vice, or new master, node 104, then CNS 216 returns the first CSSC callback invocation. CNS 216 then waits for the CSSC callback for the last switchover level that indicates the switchover of the other services has been completed. When CSSC 220 invokes the last level switchover callback on CNS 216, CNS 216 stops processing CNS requests and returns the CSSC invocation.

When all invocations return, step 508 executes by disqualifying the eligibility of old master node 102 by CSSC 220. The master-eligible attribute for old master node 102 is changed in the CMM node table in CCR 218. CMM 232 is notified by CCR 218 of the change and implements the release of the node's mastership. CMM 232 on old master node 102 informs the CMM components at the other nodes that it releases the mastership. CMM 262 on new master node 104 informs all the CMM components that it is the new master node. The CSSC components are notified by the CMM components of the mastership change, and, in turn, inform the centralized system services servers and local agents on their nodes. If other master-eligible nodes exist, a vice node election should occur and the centralized system servers on the new vice node may initialize from the spare state to become the secondary servers.

Step 510 executes by updating the connection at other nodes to the new primary server for CNS 246. Clients and agents on other nodes within cluster network 100 may update their connection information, and may receive notification of the change by the CSSC or the CMM on the node. The change also may be known by receiving an error condition when invoking the old primary servers.

Step 512 executes by updating the non-centralized system services servers on the nodes. These servers may receive notification through the CSSC, the CMM or error messages as well. The non-centralized system services remain available on the nodes.

The former master node 102 may remain in cluster network 100 or, alternatively, a repair action may bring node 102 to be perceived as having left cluster network 100. A repair action may result in a CSSC lock, or node 102 being locked out of master eligibility until recovery is completed. When the master eligibility is in effect, node 102 may participate in mastership election and may become a vice node. Cluster network 100 may not decide to do the CSSC unlock for running diagnostics on the node or other repair actions.

FIG. 5B depicts a flowchart for failing over a master node in accordance with an embodiment of the present invention. Step 520 executes by failing master node 102. A failure may be any failure from the CMM component down to the hardware that causes master node 102 to be perceived as “out” of cluster network 100. Step 522 executes by claiming mastership on behalf of vice node 104. CMM 262 elects new master in accordance with the rest of the CMM components in cluster network 100. CMM 262 also notifies the CSSC components of the change. The CSSC components notify the centralized system services servers and local agents of the mastership change.

Step 524 executes by recovering the state of each centralized system services primary server to the secondary server. The old secondaries may use checkpoint data to recover state information from the old primaries when the secondaries are promoted to primaries.

Step 526 executes by detecting the failover of master node 102 by the clients and agents on all the nodes. Non-centralized system service servers also detect failover in this manner. The nodes may synchronize their reconnection to the centralized system services by the initialization level callback invocation from their local CSSC component. For example, the nodes may detect via usage that a centralized system service is disconnected or not responding. The nodes may try to reconnect to the centralized system service server with an update of the binding to that server using the CNS service. The nodes then may detect the CNS server, such as CNS 216, is disconnected or not responding. The nodes may update the connection to CNS 216 by first querying the identification and IP address of master node 102.

If no master node is elected, then the cluster network 100 is out of service. If a new master node, such as vice node 104, is elected, then the nodes check for the former master node 102 using the CMM API. The nodes reconnect to the CNS server, such as CNS 246, and rebind to the centralized system server. If the former master is not present, then a failover is occurring and the nodes resync with the centralized system services following the initialization sequence.

Step 528 executes by electing a new vice node. A master-eligible node becomes available for election in cluster network 100 that does not have a vice master. The new availability of the master-eligible node may be due to reboot, startup, or the unlocking of the node.

FIG. 5C depicts a flowchart for promoting a node within cluster network 100 in accordance with an embodiment of the present invention. Step 530 executes by receiving notification from the CMM component that the node has been elected to the master or vice master role. The promotion may occur due to another node's failure or as a result of an administrative action. The node role changes may affect the centralized system services within cluster network 100.

Step 532 executes by transitioning the servers of the centralized system services on the promoted node to the appropriate availability state. The switchover process may be executed, as disclosed above. Step 534 executes by updating the CSSC components, such CSSC 220.

If a master node switchover is determined, CSSC 220 and the other CSSC components initiate the switchover of the centralized system services from the primary servers on the current master node to the secondary servers on the current vice node. When the transfer of these services are completed, then CSSC 220 and the other CSSC components may cause CMM 232 and the other CMM components to transfer mastership to the vice node.

In the event of a master node failover to remove the master node from cluster network 100, CSSC 250 on vice node 104 may start a failover of services upon notification from CMM 262 that a new master is established at vice node 104. CSSC 262 notifies the centralized system services servers, or the former secondary servers, to take over the services. Due to some interdependency and centralized system services readiness issues, the transfer follows the initialization levels as in the initialization function disclosed above.

Thus, by using the promote and demote functions, CSSC 220 may coordinate changes in mastership within cluster network 100. The registration with CSSC 200 includes a promote and demote callback that is the means for CSSC 220 to notify mastership changes. The centralized system services and non-centralized system services entities may use the registration with CSSC 220 to receive this notification, instead of using the registration with CMM 232. CSSC 220 also may trigger the switchover/failover processes disclosed above to promote and demote nodes. The callbacks for a switchover may be done in parallel. When all callbacks return, the centralized system services transfer to vice node 104 is considered complete. The callbacks for a failover may be done based on the initialization level sequencing. For a level, the callbacks may be done in parallel and when the callbacks of the level return, the level is considered reached.

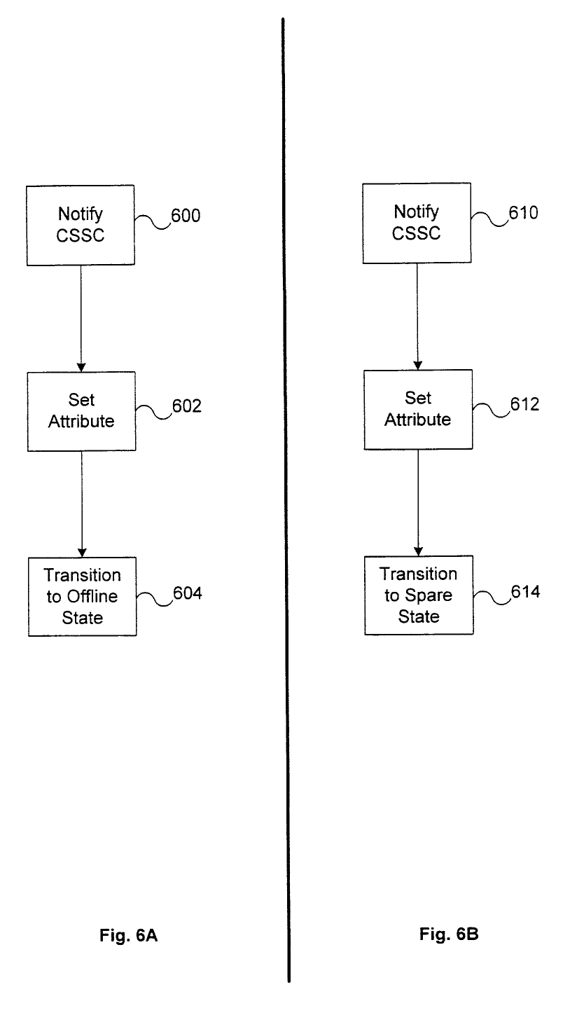

FIG. 6A depicts a flowchart for disqualifying a node in accordance with an embodiment of the present invention. Step 600 executes by notifying the CSSC component that the node is to be removed from being master-eligible. The CSSC component initiates the disqualify callback sequence. Step 602 executes by setting the node's qualification attribute to prevent the CMM component from assigning a master or vice role to the node. Step 604 executes by transitioning the servers of the centralized system services on the node to an offline state. The servers of distributed and local services may remain in an active state.

FIG. 6B depicts a flowchart for qualifying a node in accordance with an embodiment of the present invention. Step 610 executes by notifying the CSSC component that the node is to be added as master-eligible. The CSSC component initiates the qualify callback sequence. Step 612 executes by setting the node's qualification attribute to allow the CMM component to assign a master or vice role to the node. Step 614 executes by transitioning the servers of the centralized system services on the node to a spare, or standby, state. The servers of distributed and local services may remain in an active state.

The disqualify and qualify functions result in the implementation of the lock/unlock operation on the centralized system services servers on a master-eligible node. The lock operation may cause the centralized system services servers on the node not to be the primary nor the secondary servers for their respective services. The lock operation also locks the node master eligibility attribute. In particular, if the node is a master node, then a master node switchover may be performed. If the node is a vice node, then its centralized system service servers may cease to be the secondary servers and it abdicates the vice master role. At the end of this operation, the node may still be a member of cluster network 100, but its master eligibility is “locked.” The system services are available to applications on the node as their respective APIs are functional.

The unlock operation re-establishes the master eligibility of the node and may cause the centralized system services servers on the node to be part of a redundancy model for their respective services. In particular, the node may become a vice node and its centralized system services servers may become the secondary servers.

If a node is a master-eligible node, then the node may be elected vice node by the CMM protocol before the CMM level lock operation is performed. The CSSC component, however, conducting the operation may disregard this change. At some point, the master eligibility will become locked, and another master-eligible node may become vice node.

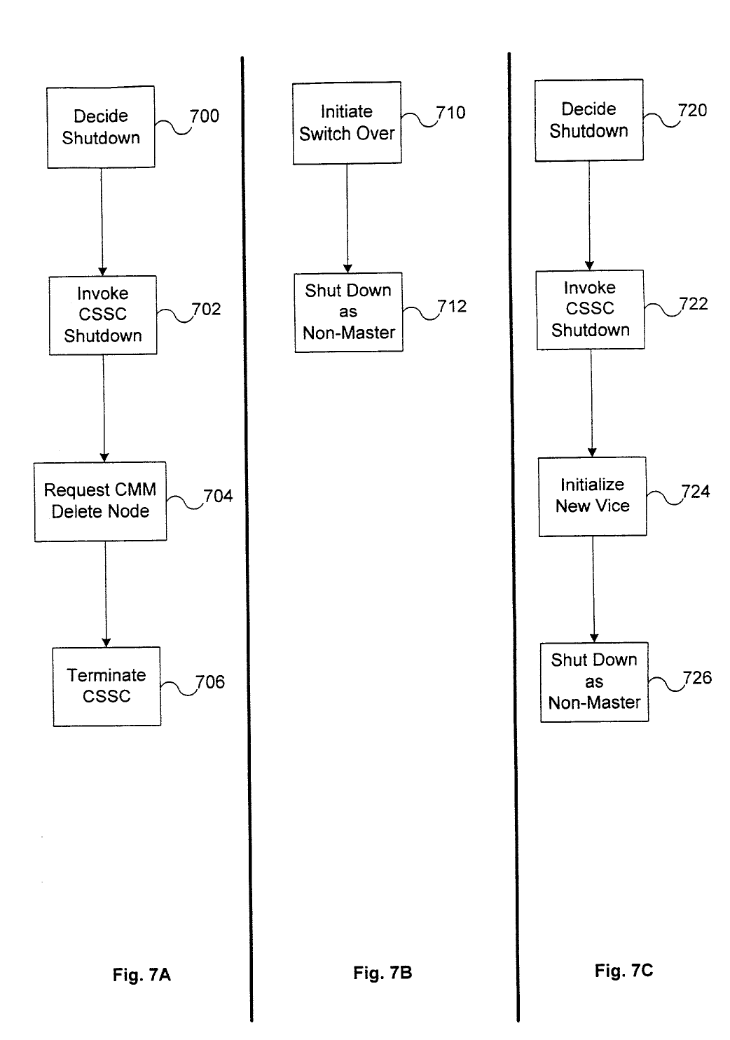

FIGS. 7A-C depict flowcharts for shutting down nodes in accordance with embodiments of the present invention. The shutdown of high availability system services may occur through gradual shutdown levels. When a node shutdown is decided, the CSSC component starts the shutdown sequence by notifying the registered servers of their shutdown level being entered. When all the shutdown levels are completed, the high availability services on that node may be considered terminated. The CSSC components then may inform the CMM component of its shutdown that will have the effect of disconnecting the node from cluster network 100. If a shutdown/reboot of the operating system also was requested, then the CSSC component may invoke the operating system shutdown/reboot operation before terminating itself.

FIG. 7A depicts a flowchart for shutting down a non-master node in accordance with an embodiment of the present invention. Step 700 executes by deciding that a node is to be shutdown. The decision may be part of an internal repair action or an external management command. Management services of cluster network 100 may be advised or aware of the shutdown so that services under their control already are switched over to redundant components, if applicable.

Step 702 executes by invoking the CSSC shutdown sequence by the management services of cluster network 100. The CMM component on the node is informed by the CSSC component that the node is shutting down. The CSSC component starts the shutdown sequence by invoking the callbacks of the centralized and non-centralized system services servers, one level at a time. When all levels are finished, the centralized and non-centralized system services are considered terminated on the node.

Step 704 executes by requesting the CMM component delete the node from cluster network 100. The request may be made by the CSSC component. The CMM component may realize this request via a special operation in the CMM protocol or by not responding to the CMM exchanges. Step 706 executes by terminating the CSSC component, only if the high availability level shutdown is requested. If an operating system shutdown also is requested, the CSSC component invokes the operating system shutdown function.

FIG. 7B depicts a flowchart for shutting down master node 102 in accordance with an embodiment of the present invention. Step 710 executes by initiating a switchover, as disclosed with reference to FIG. 5A. The switchover may be initiated by the management services of cluster network 100. After the switchover is completed, step 712 executes by shutting down former master node 102 as a non-master node, as disclosed with reference to FIG. 7A.

FIG. 7C depicts a flowchart for shutting down vice node 104 in accordance with an embodiment of the present invention. Step 720 executes by deciding vice node 104 is to be shutdown. The decision may be part of an internal repair action or an external management command. Management services of cluster network 100 may be advised or aware of the shutdown so that services under their control already are switched over to redundant components, if applicable.

Step 722 executes by invoking the CSSC shutdown sequence. The CMM component is informed by the CSSC component to abdicate the vice master role. The CMM protocol elects a new vice node, if any, and each CMM component on the nodes notifies the entities registered with it of the abdication. The notification may or may not include the identification of the new vice node.

Step 724 executes by initializing the centralized system service servers on the new vice node to become the secondary servers. The initialization may include full service state transfer or sync-up from the primary servers or even former secondary servers. The centralized system service server on the former vice node 104 transition to the spare state. Step 726 executes by shutting down as a non-master node, as disclosed with reference to FIG. 7A.

A node reboot may be implemented like a node shutdown as disclosed above, but instead of invoking the operating system shutdown function, the CSSC component invokes its reboot function. If the restart of the centralized and non-centralized system services servers, or the high availability middleware, is to be avoided on the node, then a special option may be passed to the operating system reboot function. The special option may be a part of the next boot parameters and is retrievable by the high availability initialization scripts. The special option also may stored in a local storage.

Callbacks for a shutdown level may be done in parallel. When all callbacks for that level return, that shutdown level is considered reached. When a shutdown callback is invoked, the entity should disable anything that may cause panics or critical error reports. The shutdown callback stops providing the services and responding to the requests. After returning the callback, the CSSC component may terminate the processes implementing the entity.

An entity may register for multiple shutdown levels so that it may perform its own shutdown with a better degree of synchronization. In this case, the termination is expected when its highest shutdown level is triggered.

Thus, the CSSC shutdown function may include a number of actions that can be invoked by the management services of cluster network 100. Alternatively, the CSSC component may shutdown only high availability system services. The operating system and its related non-high availability system services are not shutdown. The node becomes a stand alone node reachable via basic networking. The CSSC component may shutdown high availability system services, the operating system and its services. The control of the node is returned to the firmware. The CSSC component may reboot the node to get it back as a cluster network node. A full shutdown is performed and the operating system reboot is invoked so that the node re-initializes completely with the high availability middleware and joins cluster network 100. The CSSC component may reboot the node to get it back as a standalone node. A full shutdown is performed and the operating system reboot is invoked with an option so that the node re-initializes completely with the operating system services but the high availability middleware is not started.

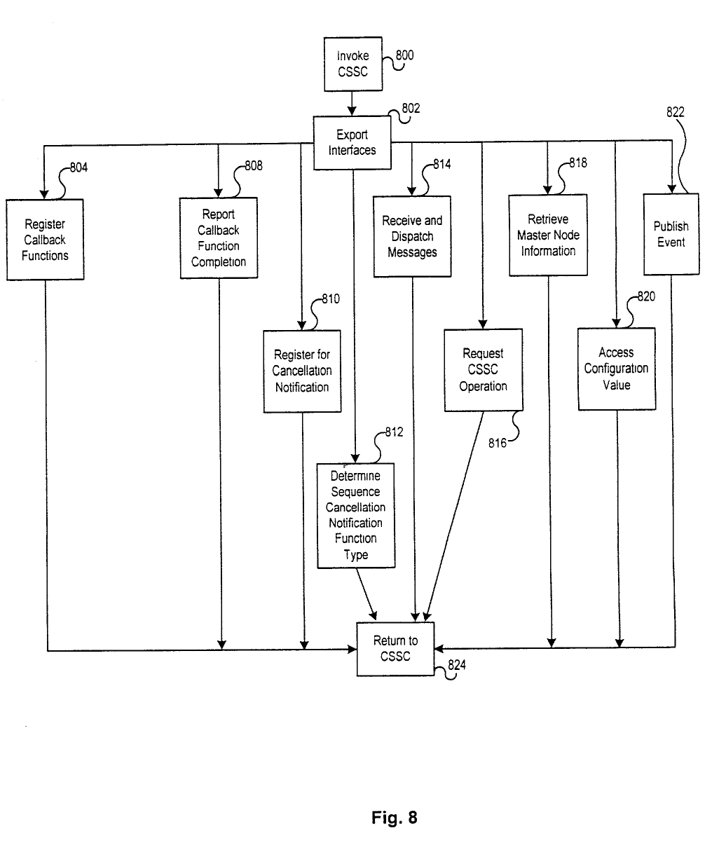

FIG. 8 depicts a flowchart for implementing CSSC functions on a cluster network in accordance with an embodiment of the present invention. The CSSC component exports interfaces for use by the centralized system services, as well as local and distributed services. Step 800 executes by invoking the CSSC component throughout the nodes, such as CSSC 220 on master node 102 in cluster network 100. Step 800 may apply when the CSSC components initialize, and receives the appropriate commands from the CMM component, the CNS, or the like. Step 802 executes by exporting interfaces to the various centralized system services. The interfaces may provide the mechanism for the centralized system services to communicate with the CSSC components, and are disclosed with regard to steps 804-822.

Step 804 executes by registering for a call back function. The exported maybe called “Registration for Callback Sequence.” The interface may have the following [symbol] ers. These parameters are provided as an example of how to implement the interface and its [symbol] ality.

NAME
cssc_register - register callback functions
SYNOPSIS - a pseudo-code example for implementing this function.
#include <cssc.h>
#define CSSC_LAST_LEVEL (−1);
typedef enum {

CSSC_INIT=1, /* Node startup */
CSSC_SHUT, /* Node shutdown */
CSSC_PROMOTE, /* Node has become master or vicemaster */
CSSC_DEMOTE, /* Node is about to lose masterhip role */
CSSC_DISQUALIFY,
/* Node is disqualified from mastership role */
CSSC_QUALIFY /* Node is qualified for masterhip role. */

} cssc_sequence_t;
typedef struct {

| | |
|---|---|
| const char | *component_name; |
| cssc_callback_t | callback_func; |
| cssc_sequence_t | sequence; |
| int | level; |
| void | *client_data; |

} cssc_regparam_t;
cssc_error_t cssc_register (const cssc_regparamt_t *reg-args);

ARGUMENTS

reg_args is a pointer to a structure containing registration arguments provided by the client. The fields of the structure include:

component_name is a pointer to a string that is the name of the system service component making the registration. The CSSC uses this name to check for expected registrations.

callback_func is a pointer to a function to be invoked by the CSSC at the sequence and level indicated by the registration.

sequence specifies the callback sequence in to invoke the callback_func.

level is an integer that indicates at which step in the callback sequence the callback function should be invoked. The value can be 0 through N, with N being the highest level defined for the callback sequence, or CSSC_LAST_LEVEL can be used to specify level N+1.

client_data is defined by the application for use in the callback function and may be NULL. It is passed as an argument to the callback.

DESCRIPTION

cssc_register ( ) registers a callback function with the CSSC. The callback is invoked at the level in the sequence indicated by the fields of the reg_args arguments. The registered callback function is only invoked for sequences executed on the local node. The callback function is expected to performs the appropriate actions and report completion of the actions to the CSSC using cssc_done ( )

Registration arguments include the name of the system service component that is doing the registration, and optional client data. The component name is used by the CSSC to check for expected registrations and for error reporting. The client data is defined by the caller for its own use, and is passed as an argument to the callback function.

The contents of the reg_args structure and the component name string are copied by the registration and do not have to be retained by the caller beyond the cssc_register ( ) call.

The caller must use the cssc_fd( ) and cssc_dispatch ( ) functions to receive and dispatch messages from the CSSC. Registering sets up the callback function to be invoked in response to messages sent from the CSSC.

A system service may register for multiple callback sequences and is expected to register for as many callback sequences as are necessary for the system service to support cluster changes and administrative operations (e.g. startup, failure recovery, and shutdown operations). A service may register at several different levels in one callback sequence, but may only have one registration for a particular sequence level.

RETURN VALUES

cssc_register ( ) returns CSSC_OK, on success, and an error code on failure. Return values are:

CSSC_OK—call succeeded

CSSC_EALREADY—a callback is already registered for the specified sequence and level

CSSC_EACCES—permission denied

CSSC_EINVAL—invalid argument

CSSC_ENOTSUP—unexpected service error

Cssc_callback_t defines the type for functions called by the CSSC during a CSSC callback sequence. When a callback function is registered with the CSSC using cssc_register ( ), a function of type cssc_callback_t is provided as a registration parameter. Clients who register callbacks are expected to use cssc_fd ( ) and cssc_dispatch ( ) to receive messages from the CSSC. Callbacks are invoked, in response to messages sent from the CSSC, at the level in the sequence indicated in the registration parameters. Callback functions are only invoked for sequences executed on the same node on which the callback is registered.

Callback functions are expected to execute the necessary actions to adjust the client to the change in node role and state that triggered the callback, and report completion of those actions by calling cssc_done ( ) with the call_tag argument that was passed in the callback invocation.

NAME
cssc_callback_t - sequence callback function type
SYNOPSIS - a pseudo-code example for implementing this function.
#include <cssc.h>
#define CSSC_FLAG_NOBOOT 0X001;
typedef void* cssc_call_tag_t;
typedef struct {

| | |
|---|---|
| cmm_nodeid_t | nodeid; |
| cmm_domainid_t | domainid; |
| unsigned int | sflag; |

} cssc_node_info_t;
typedef struct ({

| | |
|---|---|
| cssc_sequence_t | sequence; |
| int | level; |
| unsigned int | flags; |
| void | *client_data; |

const cssc_node_info_t *node_info;
} cssc_callparam_t;
typedef void (*cssc_callback_t) (const cssc_callparam_t *call_args,
cssc_call_tag_t call_tag);

ARGUMENTS

call_args points to a cssc_callparam_t structure containing the values of callback sequence registration parameters. The fields of the structure are as follows:

sequence can be CSSC_INIT, CSSC_SHUT, CSSC_PROMOTE, CSSC_DEMOTE, CSSC_DISQUALIFY, or CSSC_QUALIFY. It indicates the callback sequence in which the callback is invoked.

level is an integer that indicates at which step in the callback sequence the callback is invoked.

flags is an unsigned integer which encodes additional context the service uses to perform the callback function. Flags that can be set include:

CSSC_FLAG_NOBOOT—the shutdown sequence in which the callback is invoked will not be followed by a node reboot. Without this flag, the client should expect that the shutdown sequence will be followed by the shutdown and reboot of the node.

client_data is a value provided by the client at the time of registration. It is for the internal use of the function.

node_info is a pointer to a structure that supplies the node identifier, the node state and role, and the domain of the node as defined by the CMM. The node_info is the information on the node at the time of the start of the callback sequence in which the callback is invoked.

call_tag is the identifier for this particular invocation of the callback function. The value is used as an argument to cssc_done ( ) to report completion of the callback invocation.

Step 808 executes by reporting a sequence callback completion. The exported interface may be called “Sequence Callback Completion Report.” The interface may have the following parameters. These parameters are provided as an example of how to implement the interface and its functionality.

NAME

cssc_done—report that a callback function has completed

SYNOPSIS—a pseudo-code example for implementing this function.

#include <cssc.h>

#define CSSC_STATUS_DONE 0;

#define CSSC_STATUS_ERROR −1;

cssc_error_t cssc_done (cssc_call_tag_t call_tag, int status);

ARGUMENTS

call_tag is the callback function identifier. Its value should be the same as the identifier that is passed as an argument to the callback function when it was invoked.

status is a value that indicates the status of the completed callback function. The status value should be either CSSC_STATUS_DONE or CSSC_STATUS_ERROR.

DESCRIPTION

A call to cssc_done ( ) notifies the CSSC that an invocation of the callback function indicated by call_tag has completed. The call must be done in the same process that registered the callback function, and in which the callback function is invoked. The value of call_tag is the same as the value passed as an argument to the callback function when it is invoked.

When a callback function is invoked by the CSSC, the client of the service must call cssc_done ( ) to report its completion. If the CSSC does not receive the notification or the status value is CSSC_STATUS_ERROR, it reports an error to the Component Error Correlator (CEC), and it cannot proceed to the next level of the control sequence.

RETURN VALUES

cssc_done ( ) returns CSSC_OK on success and an error code on, failure. Return values are:

CSSC_OK—call succeeded

CSSC_EACCES—permission denied

CSSC_EINVAL—invalid argument

CSSC_ENOENT—callback registration does not exist

CSSC_ENOTSUP—unexpected service error

CSSC_ESRCH—no callback invocation is active

Step 810 executes by registering for cancellation notification. The exported interface may be called “Registration for Cancellation Notification.” The interface may have the following parameters. These parameters are provided as an example of how to implement the interface and its functionality.

NAME

cssc_notify_registration—register for notification of sequence cancellation

SYNOPSIS—a pseudo-code example for implementing this function.

#include <cssc.h>

cssc_notify_registration (cssc_notify_t notify_func);

ARGUMENTS

notify_func is a pointer to a function to be invoked by the CSSC if the CSSC cancels a callback sequence.

DESCRIPTION

cssc_notify_registration ( ) registers a function with the CSSC to receive notification of the cancellation of a callback sequence on the local node. Sequence cancellation is the situation where some callbacks registered for a sequence are invoked, but the CSSC decides not to invoke all callbacks registered for the sequence. If the CSSC cancels a sequence on a node, all notification functions registered by clients on that node are invoked.

Clients are expected to use the cssc_fd ( ) and cssc_dispatch ( ) to receive notifications. The registered notification function is called by cssc_dispatch ( ) when the notification is received. Only one notification function may be registered by a process.

RETURN VALUES

cssc_notify_registration ( ) returns CSSC_OK if the registration succeeds, and an error code on failure. Return values are:

CSSC_OK—call succeeded

CSSC_EALREADY—a notification function is already registered

CSSC_EACCES—permission denied

CSSC_EINVAL—invalid argument

CSSC_ENOTSUP—unexpected service error

Step 812 executes by determining a sequence cancellation notification function type. The exported interface may be called “Cancellation Notification Function Type.” The interface may have he following parameters. These parameters are provided as an example of how to implement the interface and its functionality.

NAME

cssc_notify_t—sequence cancellation notification function

SYNOPSIS—a pseudo-code example for implementing this function.

#include <cssc.h>

void (*cssc_notify_t) (cssc_sequence_t canceled_sequence, int last_level);

ARGUMENTS

canceled_sequence is a value indicating the sequence that was canceled, and can be CSSC_INIT, CSSC_PROMOTE, CSSC_DEMOTE, CSSC_DISQUALIFY, or CSSC_QUALIFY, or

last_level indicates the level at which the last callback registered for the sequence was invoked.

DESCRIPTION cssc_notify_t defines the type for functions called by the CSSC when a callback sequence is canceled. Functions of this type that are registered on a node using cssc_notify_register ( ) are invoked when the CSSC cancels a callback sequence on the node.

Sequence cancellation is the situation where some callbacks registered for a sequence are invoked, but the CSSC decides not to invoke all callbacks registered for the sequence.

Cancellation occurs because an operation or cluster change causes the CSSC either to restart a sequence with different callback arguments or to start a different sequence. For example, if a node that is going through its initialization sequence is elected master during that sequence, the CSSC cancels the sequence, and restarts the initialization at the first sequence level with callback arguments indicating the new status of the node. Another example is the CSSC receives a request to shutdown a node while it is going through a qualification sequence, the CSSC cancels the qualification sequence.

Step 814 executes by receiving and dispatching a message. The exported interface may be called “Message Receipt and Dispatch.” The interface may have the following parameters. These parameters are provided as an example of how to implement the interface and its functionality.

NAME

cssc_fd, cssc_dispatch—control action message receipt and dispatch

SYNOPSIS—a pseudo-code example for implementing this function.

#include <cssc.h>

cssc_error_t cssc_fd(int*fd_out);

cssc-error_t cssc_dispatch(int_fd);

ARGUMENTS

fd_out is a pointer to a location allocated by the caller. If the call to cssc_fd( ) succeeds, the location is set to the value of a file descriptor through which the CSSC sends messages.

fd is the file descriptor on which a message from the CSSC has been detected.

DESCRIPTION

cssc_fd ( ) returns through its fd_out parameter a file descriptor that system services can use with select(3C) or poll(2) to detect messages from the CSSC.

cssc_dispatch ( ) processes any messages from the CSSC and invokes the appropriate registered callback function.

A system service that uses the CSSC service must use cssc_fd ( ) and cssc_dispatch ( ) to receive and process messages. Messages from the CSSC are sent through the file descriptor returned from cssc_fd ( ). The application uses select (3C) or poll(2) to detect the arrival of a message, and then calls cssc_dispatch ( ) to process the message. The dispatch function calls the appropriate registered callback function to run the control action. If no messages have arrived an error is returned with error set to ENOMSG.

RETURN VALUES

On success, cssc_fd ( ) returns CSSC_OK, and sets the location pointed to by the fd_out argument to a file descriptor on which the CSSC sends messages. An error code is returned on failure, and the location pointed-to by the fd_out argument is not changed.

cssc_dispatch ( ) returns CSSC_OK on success and an error code on failure.

Return values are:

CSSC_OK—call succeeded

CSSC_EACCES—permission denied

CSSC-EBADF—bad file descriptor

CSSC-ENOMSG—missing or invalid message

CSSC-ENOTSUP—unexpected service error

Step 816 executes by requesting a CSSC operation. The exported interface may be called “Operation Request.” The interface may have the following parameters. These parameters are provided as an example of how to implement the interface and its functionality.

NAME
cssc_op_request - request a cssc operation
SYNOPSIS - a pseudo-code example for implementing this function.
typedef enum{CSSC_RES_COMPLETED, CSSC_RES_FAILED}
cssc_result_t;
typedef void(*cssc_result_t) (cssc_result_t result, void *client_data);
typedef enum(CSSC_OP_DISQUALIFY, CSSC_OP_QUALIFY,
CSSC_OP_SHUTDOWN) cssc_op_t
typedef struct {

| | |
|---|---|
| cssc_op_t | operation; |
| cmm_nodeid_t | node_id; |
| unsigned int | flags; |
| cssc_result_t | result_func; |
| void | *client_data; |

} cssc_opparam_t;
cssc_error_t cssc_op_request (const cssc_opparam_t *op_args);

ARGUMENTS

op_args is a pointer to a structure whose contents indicate the operation being requested, and provides the arguments for the operation. The fields of the structure include:

operation is a cssp_op_t value indicating the operation being requested on the node indicated by the node_id field. Values are CSSC_OP_DISQUALIFY, CSSC_OP_QUALIFY and CSSC_OP_SHUTDOWN.

node_id indicates which node the operation is to be preformed on.

flags is an operation specific set of OR-ed together bit flags that modify the interpretation of the operation. Currently only the flag CSSC_FLAG_NOBOOT is defined for the CSSC_OP_SHUTDOWN operation.

result_func is a pointer to a function that is invoked through the cssc_dispatch ( ) API routine to report the result of the operation back to the requester.

client_data is defined by the client for use in the result callback function and may be NULL. It is passed as an argument to the result callback function.

DESCRIPTION

cssc_op_request ( ) provides an interface that allows other CGHA system services to initiate control operations on a node. The request invokes an operation to change the state or mastership role of the node, and may trigger callback sequences. Operations that may be requested are CSSC_OP_DISQUALIFY, CSSC_OP_QUALIFY and CSSC_OP_SHUTDOWN

CSSC_OP_DISQUALIFY indicates an operation to disqualify the node from playing the master or vicemaster role. If the node being disqualified is in the master or vicemaster role, the disqualification of the node also causes a switchover of the primary or secondary servers of the centralized system services. If a master or vicemaster node is disqualified, the CSSC first invokes the CSSC_DEMOTE callback sequence to cause the servers of the centralized services to transition to a spare state. The CSSC then induces the CMM to elect a new master or vicemaster. On the newly elected master or vicemaster, the CSSC invokes the CSSC_PROMOTE callback sequence to allow the centralized system services to transition to the primary state on a new master, or to the secondary state on a new vicemaster. After any needed demotion is accomplished, the node's attribute is set to disqualify it from mastership election, and the CSSC invokes a CSSC_DISQUALIFY callback sequence to allow the servers of the centralized services to transition to an offline state.

CSSC_OP_QUALIFY indicates an operation to set the node's attributes so that is a candidate for master or vicemaster election. The request causes the CSSC to change the node's attribute so that it is qualified for master or vicemaster election. The CCSSC then initiates the CSSC_QUALIFY callback sequence to allow the centralized system services on the node to transition from offline to a spare state.

CSSC_OP_SHUTDOWN indicates an operation to shutdown the CGHA services system take the node out of the cluster. If the node being shutdown is qualified for master election, the CSSC first performs all of the actions associated with CSSC_OP_DISQUALIFY to put it in a disqualified state. The CSSC then initiates the CSSC_SHUT callback sequence, and the actions during the sequence are expected to terminate the CGHA system service in an orderly manner. By default, the CSSC initiates an operating-system shutdown and reboot after the CSSC_SHUT sequence completes. If the CSSC_FLAG_NOBOOT flag is set in the flags field of the shutdown request parameters, the CGHA system services are shutdown without rebooting the node.

The client requesting the operation is expected to use the cssc_fd( ) and cssc_dispatch( ) functions to receive notification of the result of the operation request. When the result is received, the cssc_dispatch( ) function invokes the result_func function that was provided with the operation request. The first argument in the result callback indicates the result of the operation request:

CSSC_RES_COMPLETED indicates that the requested operation successfully completed and CSSC_RES_FAILED indicates that the requested operation failed. The second argument in the result callback gives the client_data value that was provided with the operation request.

RETURN VALUES

cssc_op_request( ) returns CSSC_OK if the request is accepted, and an error code if the request fails. The return value indicate only that the request is accepted and that the CSSC will attempt the requested operation. The result of whether the requested operation succeeded or failed is returned through the cssc_result_t function that is provided with the operation request. cssc_op_request( ) return values are:

CSSC_OK—request accepted

CSSC_EACCES—permission denied

CSSC_EINVAL—invalid argument

CSSC_EALREADY—action already in progress

CSSC_ENOTSUP—unexpected service error

Step 818 executes by retrieving master node information. The exported interface may be called “Services Ready Information.” The interface may have the following parameters. These parameters are provided as an example of how to implement the interface and its functionality.

NAME

cssc_master_ready—retrieves information about the location of the master node and the availability of system services on that node.

SYNOPSIS—a pseudo-code example for implementing this function.

#include <cssc.h>

cssc_error_t cssc_master_ready(cmm_nodeid_t &id_out);

ARGUMENTS

id_out is the identifier of the node where the primary centralized system services are running, also known as the master node.

DESCRIPTION

This routine retrieves the identifier of the node where the primary centralized system services are running. A caller can use the information to determine whether the CGHA platform is operational. An error is returned when the primary centralized services are not ready indicating an initialization or recovery operation is underway.

RETURN VALUES

cssc_master_ready ( ) returns CSSC_OK on success, and an error code on failure. Return values are:

CSSC_OK—call succeeded

CSSC_EAGAIN—information temporarily unavailable

CSSC_ENOTSUP—unexpected service error

Step 820 executes by accessing a configuration value, such as a parameter or a constraint. The exported interface may be called “Configuration Parameter Access.” The interface may have the following parameters. These parameters are provided as an example of how to implement the interface and its functionality.

NAME

cssc_conf_get—access the value of a configuration parameter or constant.

SYNOPSIS—a pseudo-code example for implementing this function.

#include <cssc.h>

cssc_conf_get (cssc_conf_t tag, . . . );

ARGUMENTS

tag is a symbolic value indicating a CSSC configuration parameter or constant whose value is to be retrieved. The type and number of additional arguments are determined by the tag, and include an address at which to deposit the retrieved parameter value.

The accepted cssc_conf_t values, and the additional arguments expected given the value as the tag argument in a cssc_conf_get ( ) call are indicated in the following table:

| | Additional | |
|---|---|---|
| Tag Value | Arguments | Description |
| CSSC_CONF_CHANNEL | char | Gets the name of the event channel |
| | *buffer, int | upon which the CSSC publishes events. |
| | size | buffer is the location of a character |
| | | array in which the retrieved value is |
| | | stored. size is the number of bytes in |
| | | the array. |
| CSSC_CONF_EVT_MASTER | char | Get the pattern used in master-ready |
| READY | *buffer, int | events published by the CSSC. |
| | size | buffer is the location of a character |
| | | array in which the retrieved value is |
| | | stored. size is the number of bytes in |
| | | the array. |
| CSSC_CONF_EVT_DISQUALIFY | char | Get the pattern used in node- |
| | *buffer, int | disqualified events published by the |
| | size | CSSC. |
| | | buffer is the location of a character |
| | | array in which the retrieved value is |
| | | stored. size is the number of bytes in |
| | | the array. |
| CSSC_CONF_EVT_QUALIFY | char | Get the pattern used in node- |
| | *buffer, int | disqualified events published by the |
| | size | CSSC. |
| | | buffer is the location of a character |
| | | array in which the retrieved value is |
| | | stored. size is the number of bytes in |
| | | the array. |

DESCRIPTION

cssc_conf_get( ) retrieves the value of the CSSC configuration parameter or constant. The initial tag argument indicates what parameter or constant is to be retrieved, and also determines what additional arguments are expected. Additional arguments include an “out” parameter that provides a location to store the retrieved parameter value, and size information if the location points to a string buffer. A successful call to cssc_conf_get ( ) results in the location provided in the tag-specific arguments to be updated with the value of the configuration parameter indicated by the tag.

RETURN VALUES

cssc_conf_get ( ) returns CSSC_OK on success and an error code on failure. Return values are:

CSSC_OK—call succeeded

CSSC_E2BIG—value too big for buffer size

CSSC_EAGAIN—information temporarily unavailable

CSSC_ENOTSUP—unexpected service error

Step 822 executes by publishing an event.

The CSSC publishes Cluster Event Service events to notify interested subscribers of actions it takes. There is one event channel on which the CSSC publishes all events. The CSSC event channel name, and the patterns with which clients subscribe to events are accessed with the cssc_conf_get( ) function. The channel name is accessed using the CSSC_CONF_CHANNEL access tag. The events published by the CSSC are as follows.

Master Ready—This event is published when the CSSC_INIT or CSSC_PROMOTE sequence completes successfully on the master node. It indicates that the servers of the CSSC coordinated centralized system services on the master have completed their transition to primary state and are ready to provide service. The string value of the first pattern in the published event may be accessed using cssc_conf_get ( ) with the access tags CSSC_CONF_EVT_MASTER_READY. The data published with the event is the cmm_nodeid_t type nodeid of the master node.

Node Disqualified—This event is published when the CSSC_DISQUALIFY sequence completes successfully on a node. It indicates that the node has been disqualified as a candidate for master election. The string value of the first pattern in the event may be accessed using cssc_conf_get ( ) with the tag CSSC_CONF_EVT_DISQUALIFY. The data published with the event is the cmm_nodeid_t type nodeid of the disqualified node.

Node Qualified—This event is published when the CSSC_QUALIFY sequence completes successfully on a node. It indicates that the node has become qualified as a candidate for master election. The string value of the first pattern in the event may be accessed using cssc_conf_get ( ) with the tag CSSC_CONF_EVT_DISQUALIFY. The data published with the event is the cmm_nodeid_t type nodeid of the qualified node.

Step 824 executes by returning to the CSSC component to coordinate the centralized system services using the disclosed interfaces.

It will be apparent to those skilled in the art that various modifications and variations can be made in the embodiments disclosed herein without departing from the spirit or scope of the invention. Thus, it is intended that the present invention covers the modifications and variations of the disclosed embodiments of the present invention provided they come within the scope of the appended claims and their equivalents.

What is claimed is:

1. A network having a plurality of nodes for exchanging information, comprising:
a master node within said plurality of nodes, said master node including a primary server to run a centralized system service; and
a system services coordinator on each of said plurality of nodes to coordinate a function regarding said centralized system service.

2. The network of claim 1, comprising:
wherein said plurality of nodes includes a vice node, said vice node including a secondary server to run said centralized system service.

3. The network of claim 1, wherein said master node communicates via a carrier grade transport protocol.

4. The network of claim 1, wherein said master node includes a cluster membership monitor, said cluster membership monitor providing instructions to said system services coordinator.

5. The network of claim 1, wherein said function is an initialization function.

6. The network of claim 1, wherein said function comprises a shut down function.

7. The network of claim 1, wherein said function comprising a promote function.

8. The network of claim 1, wherein said function comprises a demote function.

9. The network of claim 1, wherein said function comprises a disqualify function.

10. The network of claim 1, wherein said function comprising a qualify function.

11. The network of claim 1, wherein said plurality of nodes includes a master-eligible node.

12. The network of claim 1, wherein said system services coordinator registers callback actions for said centralized system service.

13. The network of claim 1, wherein said centralized system service registers with said system services coordinator.

14. A node within a network of nodes for exchanging information, comprising:
a centralized system service to run on a primary server, and
a system services coordinator to coordinate a function regarding said centralized system service.

15. The node of claim 14, further comprising a cluster membership monitor to provide instructions to said system services coordinator.

16. The node of claim 14, wherein said centralized system service comprises a naming service.

17. The node of claim 14, wherein said centralized system service comprises a component role assignment manager.

18. The node of claim 14, wherein said centralized system service communicates via a carrier grade transport protocol.

19. The node of claim 14, further comprising a high availability level and an operating system level.

20. The node of claim 19, wherein said system service coordinator resides in said high availability level.

21. The node of claim 14, wherein said function comprises an initialization function.

22. The node of claim 14, wherein said function comprises a shut down function.

23. The node of claim 14, wherein said function comprises a promote function.

24. The node of claim 14, wherein said function comprises a demote function.

25. The node of claim 14, wherein said function comprises a disqualify function.

26. The node of claim 14, wherein said function comprises a qualify function.

27. The node of claim 14, wherein said function includes a callback sequence.

28. A network of a plurality of nodes, comprising:
a master node having a primary server to run a centralized system service;
a vice node having a secondary server to run said centralized system service; and
a system services coordinator to coordinate functions regarding said centralized system service at said plurality of nodes.

29. The network of claim 28, wherein said secondary server mirrors said primary server.

30. The network of claim 28, wherein said centralized system service comprises a component role assignment manager to coordinate an application at said plurality of nodes.

31. A method for coordinating a system service within a network having a plurality of nodes, comprising:
receiving a request at a system services coordinator, said system services coordinator having a component at each of said plurality of nodes;
using a callback sequence for performing a function at one of said plurality of nodes in response to said request; and
reacting to said function by said system services coordinator on said node and communicating said reaction to said system services coordinator.

32. The method of claim 31, wherein said using includes invoking callback functions having levels, said levels correlating to completing stages of said callback functions.

33. The method of claim 32, further comprising receiving said levels at said system services coordinator as said stages are completed.

34. The method of claim 31, further comprising registering said callback sequence with said system services coordinator.

35. The method of claim 34, wherein said callback sequence is registered from said system services coordinator.

36. The method of claim 31, further comprising transitioning said system services according to said callback sequence.

37. The method of claim 31, further comprising interfacing said system services with said plurality of nodes.

38. A method for coordinating a function for a system service server on a node, comprising:
receiving a callback sequence at said system service server from a system services coordinator;
determining levels of said callback sequence, said levels correlating to stages of completing said function;
receiving said levels at said system services coordinator; and
publishing events from said node by said system services coordinator correlating to said received levels.

39. The method of claim 38, further comprising communicating said levels to said primary server.

40. The method of claim 38, wherein said system service server resides on a master node, and said system services coordinator interfaces with said master node.

41. A method for initializing a node within a network having centralized system services, comprising:
registering said centralized system services on said node with a system services coordinator;
triggering an initialization function having levels; and
receiving notification at said system services coordinator for completing said levels.

42. The method of claim 41, further comprising retrieving boot parameters for said node.

43. The method of claim 41, further comprising starting up an operating system on said node.

44. The method of claim 41, further comprising loading a configuration table of said network.

45. The method of claim 41, further comprising participating in formation protocol for said network by sending information about said node.

46. The method of claim 41, further comprising initializing non-centralized system services on said node by registering said non-centralized system services with said system services coordinator.

47. A method for coordinating initialization in a network having a plurality of nodes, comprising:
registering centralized system services within said network with a system services coordinator;
electing a master node within said network and sending information on said master node to said plurality of nodes;
using callbacks registered at said system services coordinator to trigger initialization levels at said plurality of nodes; and
informing said plurality of nodes when said master node completes said initialization levels via said system services coordinator.

48. The method of claim 47, further comprising registering said system services coordinator with a membership monitor within said network.

49. The method of claim 48, wherein said electing includes claiming said master node by said membership monitor.

50. The method of claim 47, further comprising reading a configuration table of said network.

51. The method of claim 47, further comprising electing a vice node within said network.

52. A method for switching over a master node having primary servers for centralized system services within a network having a plurality of nodes, comprising:
informing a system services coordinator on said master node of a loss of master eligibility on said master node;
invoking switchover callbacks registered at said system services coordinator; and
transferring states of said primary servers to secondary servers for said centralized system services at a vice node.

53. The method of claim 52, further comprising updating said plurality of nodes on said transferred states via said system services coordinator.

54. The method of claim 52, further comprising updating non-centralized system services via said system services coordinator.

55. The method of claim 52, further comprising triggering a switchover condition on said master node.

56. A method for failing a master node having primary servers for centralized system services within a network having a plurality of nodes, comprising:
claiming mastership of said network at a vice node and informing said centralized system services via a system services coordinator; and
recovering states of said primary servers on said master node to secondary servers of said centralized system services on said vice node.

57. The method of claim 56, further comprising detecting that said primary servers have been transferred.

58. The method of claim 56, further comprising synchronizing a reconnection to said centralized system services at said plurality of nodes via said system services coordinator.

59. The method of claim 56, further comprising detecting a failover condition at said master node.

60. The method of claim 56, further comprising electing another vice node.

61. A method for demoting a master eligible node within a network for exchanging information, comprising:
initiating a demote callback sequence from a system services coordinator;
transitioning centralized system services servers on said node to a spare state; and
updating said system services coordinator.

62. The method of claim 61, further comprising triggering a switchover on said node.

63. The method of claim 61, further comprising detecting a failover condition on said node.

64. The method of claim 61, further comprising notifying said system services coordinator that said node is to be demoted.

64. A method for promoting a node to be master eligible within a network for exchanging information, comprising:
initiating a promote callback sequence from a system services coordinator;
transitioning centralized system services servers on said node to an availability state, and
updating said system services coordinator.

65. The method of claim 64, further comprising notifying said system services coordinator that said node is to be promoted.

66. A method for disqualifying a node from being master eligible within a network for exchanging information, comprising:
initiating a disqualify callback sequence from a system services coordinator;
setting a master eligible attribute at said node; and
transitioning centralized system servers on said node to an offline state.

67. The method of claim 66, further comprising notifying said system services coordinator that said node is to be disqualified.

68. A method for qualifying a node to be master eligible within a network for exchanging information, comprising:
initiating a qualify callback sequence from a system services coordinator;
setting a master eligible attribute at said node; and
transitioning centralized system servers on said node to a spare state.

69. The method of claim 68, further comprising notifying said system services coordinator that said node is to be promoted.

70. A method for shutting down a node within a network for exchanging information, comprising:
invoking callbacks of centralized system services on said node by a system services coordinator;
requesting said node be removed from said network by said system services coordinator; and
terminating said system services coordinator.

71. The method of claim 70, further comprising terminating said centralized system services when all callbacks are received at said system services coordinator.

72. The method of claim 70, further comprising shutting down said operating system at said node.

73. The method of claim 70, wherein said node is a master node within said network.

74. The method of claim 73, further comprising initiating a switchover on said master node.

75. The method of claim 70, wherein said node is a vice node within said network.

76. The method of claim 75, further comprising initializing another vice node.

77. The method of claim 70, further comprising rebooting said node.

78. A method for removing a node from a network, comprising:
initiating a shutdown callback sequence from a system services coordinator, wherein said shutdown callback sequence includes levels;
notifying said system services as said levels are completed and terminating centralized system services on said node; and
terminating said system service coordinator.

79. The method of claim 78, further comprising requesting said node be deleted from said network.

80. A method for coordinating centralized system services on a node within a network, said network exchanging information with said node, comprising:
initializing said node by an initialization function according to a system services coordinator;
invoking a callback sequence at said node by said system services coordinator;
updating said centralized system services and non-centralized system services with information received by said system services coordinator;
communicating with a master node within said network and synchronizing said initialization function with said master node;
determining a change in configuration of said node within said network; and
executing a function at said node according to said system services coordinator, said function responding to said change in configuration.

81. The method of claim 80, further comprising notifying a membership monitor of said network of said change of configuration by said system services coordinator.

82. A computer program product comprising a computer useable medium having computer readable code embodied therein for coordinating a system service within a network having a plurality of nodes, the computer program product adapted when run on a computer to execute steps, including:
receiving a request at a system services coordinator, said system services coordinator having a component at each of said plurality of nodes;
using a callback sequence for performing a function at one of said plurality of nodes in response to said request; and
reacting to said function by said system service on said node and communicating said reaction to said system services coordinator.

83. A computer program product comprising a computer useable medium having computer readable code embodied therein for coordinating a function for a system on a node, the computer program product adapted when run on a computer to execute steps including:
receiving a callback sequence at said system service from a system services coordinator, said system services coordinator in communication with a primary server of said system service;
determining levels of said callback sequence, said levels correlating to stages of completing said function;
receiving said levels at said system services coordinator; and
publishing events from said node by said system services coordinator correlating to said received levels.

84. A computer program product comprising a computer useable medium having computer readable code embodied therein for initializing a node within a network having centralized system services, the computer program product adapted when run on a computer to execute steps including:
registering said centralized system services on said node with a system services coordinator;
triggering an initialization function having levels; and
receiving notification at said system services coordinator for completing said levels.

85. A computer program product comprising a computer useable medium having computer readable code embodied therein for coordinating initialization in a network having a plurality of nodes, the computer program product adapted when run on a computer to execute steps including:
registering centralized system services within said network with a system services coordinator;
electing a master node within said network and sending information on said master node to said plurality of nodes;
using callbacks registered at said system services coordinator to trigger initialization levels at said plurality of nodes; and
informing said plurality of nodes when said master node completes said initialization levels via said system services coordinator.

86. A computer program product comprising a computer useable medium having computer readable code embodied therein for switching over a master node having primary servers for centralized system services within a network having a plurality of nodes, the computer program product adapted when run on a computer to execute steps including:
informing a system services coordinator on said master node of a loss of master eligibility on said master node;
invoking switchover callbacks registered at said system services coordinator; and
transferring states of said primary servers to secondary servers for said centralized system services at a vice node.

87. A computer program product comprising a computer useable medium having computer readable code embodied therein for failing a master node having primary servers for centralized system services within a network having a plurality of nodes, the computer program product adapted when run on a computer to execute steps including:
claiming mastership of said network at a vice node and informing said centralized system services via a system services coordinator; and
transferring states of said primary servers on said master node to secondary servers of said centralized system services on said vice node.

88. A computer program product comprising a computer useable medium having computer readable code embodied therein for demoting a master eligible node within a network for exchanging information, the computer program product adapted when run a computer to execute steps including:
initiating a demote callback sequence from a system services coordinator;
transitioning centralized system services servers on said node to a spare state; and
updating said system services coordinator.

89. A computer program product comprising a computer useable medium having computer readable code embodied therein for promoting a node to be master eligible within a network for exchanging information, the computer program product adapted when run on a computer to execute steps including:
initiating a promote callback sequence from a system services coordinator;
transitioning centralized system services servers on said node to an availability state, and
updating said system services coordinator.

90. A computer program product comprising a computer useable medium having computer readable code embodied therein for disqualifying a node from being master eligible within a network for exchanging information, the computer program product adapted when run on a computer to execute steps including:
initiating a disqualify callback sequence from a system services coordinator;
setting a master eligible attribute at said node; and
transitioning centralized system servers on said node to an offline state.

91. A computer program product comprising a computer useable medium having computer readable code embodied therein for qualifying a node to be master eligible within a network of exchanging information, the computer program product adapted when run on a computer to execute steps including:
initiating a qualify callback sequence from a system services coordinator;
setting a master eligible attribute at said node; and
transitioning centralized system servers on said node to a spare state.

92. A computer program product comprising a computer useable medium having computer readable code embodied therein for shutting down a node within a network for exchanging information, the computer program product adapted when run on a computer to execute steps including:
invoking callbacks of centralized system services on said node by a system services coordinator;
requesting said node be removed from said network by said system services coordinator; and
terminating said system services coordinator.

93. A computer program product comprising a computer useable medium having computer readable code embodied therein for removing a node from a network, the computer program product adapted when run on a computer to execute steps including:
initiating a shutdown callback sequence from a system services coordinator, wherein said shutdown callback sequence includes levels;
notifying said system services as said levels are completed and terminating centralized system services on said node; and
terminating said system service coordinator.

94. A computer program product comprising a computer useable medium having computer readable code embodied therein for coordinating centralized system services on a node within a network, said network exchanging information with said node, the computer program product adapted when run on a computer to execute steps including:
initializing said node by an initialization function according to a system services coordinator;
invoking a callback sequence at said node by said system services coordinator;
updating said centralized system services and non-centralized system services with information received by said system services coordinator;
communicating with a master node within said network and synchronizing said initialization function with said master node;
determining a change in configuration of said node within said network; and
executing a function at said node according to said system services coordinator, said function responding to said change in configuration.
